(19) United States
(12) Patent Application Publication
(10) Pub. No.: US 2025/0245726 A1
(43) Pub. Date: Jul. 31, 2025

(54) SYSTEMS AND METHODS FOR PERSONA-BASED MIXED CROSS ITEM TYPE RECOMMENDATIONS

(71) Applicant: Walmart Apollo, LLC, Bentonville, AR (US)

(72) Inventors: Murali Mohana Krishna Dandu, San Jose, CA (US); Rahul Sridhar, Santa Clara, CA (US); Sinduja Subramaniam, Sunnyvale, CA (US); Yue Xu, San Francisco, CA (US); Shreyas Saiprasad Jadhav, San Francisco, CA (US); Evren Korpeoglu, San Jose, CA (US); Kannan Achan, Saratoga, CA (US)

(21) Appl. No.: 19/025,759

(22) Filed: Jan. 16, 2025

Related U.S. Application Data
(60) Provisional application No. 63/627,384, filed on Jan. 31, 2024.

(51) Int. Cl. G06Q 30/0601

(52) U.S. Cl. CPC G06Q 30/0631; G06Q 30/0633

(57) ABSTRACT

This application is directed to systems and methods for information recommendation. In some embodiments, a disclosed method includes obtaining historic interaction data associated with past interactions of a plurality of users with a plurality of information items; generating a first set of item types involved in the past interactions jointly with an anchor item type; generating a second set of item types semantically associated with the anchor item type, e.g., for a user class; combining the first set of item types and the second set of item types to generate a list of target item types; generating a list of recommended information items based on the list of target item types; and in response to a first user's interaction with the anchor item type, enabling display of at least a subset of information items in the list of recommended information items on an electronic device associated with the first user.

### RELATED APPLICATION

This application claims benefits of U.S. Provisional Application No. 63/627,384, filed Jan. 31, 2024, titled “Systems and Methods for Persona-Based Mixed Cross Item Type Recommendations,” which is incorporated by reference in its entirety.

### TECHNICAL FIELD

This application relates generally to information processing and, more particularly, to systems and methods for recommending information items based on user classes.

### BACKGROUND

Some cloud-based service platforms provide additional data items in response to a user indication of interest in one or more particular data items. The additional data items may belong to the same category as, or a different category from, the data item(s) that have attracted the user's interest. The additional data items are normally ranked to enhance visibility and accessibility of products associated with the data items to users, thereby improving user engagement. Logs are recorded to track each individual user's activities on the service platform and become valuable resources that provide information about the additional data items. While individual users' activity information could be useful for identifying the additional data items, it encompasses a limited number of data items, and can only be applied to identify additional data items that are closely related to the data item(s) that have attracted the user's interest. This inevitably compromises a scope and an engagement level of the additional data items that can be identified for individual users, especially when information associated with a general population is accessible to provide context information and millions of data items belonging to numerous of categories are available for selection.

### SUMMARY

In various embodiments, a system including a non-transitory memory configured to store instructions thereon and at least one processor is disclosed. The at least one processor is configured to obtain historic interaction data associated with past interactions of a plurality of users with a plurality of information items. Each information item corresponds to a respective item type. The at least one processor is further configured to generate a first set of item types including item types involved in the past interactions jointly with an anchor item type based on the historic interaction data of the plurality of users. The at least one processor is further configured to generate a second set of item types using a type selection model configured to identify item types semantically associated with the anchor item type, e.g., independently of the historic interaction data of the plurality of users. The at least one processor is further configured to combine the first set of item types and the second set of item types to generate a list of target item types; generate a list of recommended information items based on the list of target item types; and in response to detection of a user interaction with the anchor item type by a first user, enable display of at least a subset of information items in the list of recommended information items to the first user on an electronic device associated with the first user.

In various embodiments, a computer-implemented method is disclosed. The computer-implemented method includes a step of obtaining historic interaction data associated with past interactions of a plurality of users with a plurality of information items, each information item corresponding to a respective item type. The computer-implemented method further includes steps of generating a first set of item types including item types involved in the past interactions jointly with an anchor item type based on the historic interaction data of the plurality of users. The computer-implemented method further includes steps of generating a second set of item types using a type selection model configured to identify item types semantically associated with the anchor item type, e.g., independently of the historic interaction data of the plurality of users. The computer-implemented method further includes steps of combining the first set of item types and the second set of item types to generate a list of target item types; generating a list of recommended information items based on the list of target item types; and in response to detection of a user interaction with the anchor item type by a first user, enabling display of at least a subset of information items in the list of recommended information items to the first user on an electronic device associated with the first user.

In various embodiments, a non-transitory computer readable medium having instructions stored thereon is disclosed. The instructions, when executed by at least one processor, cause at least one device to perform operations including obtaining historic interaction data associated with past interactions of a plurality of users with a plurality of information items, each information item corresponding to a respective item type; generating a first set of item types including item types involved in the past interactions jointly with an anchor item type based on the historic interaction data of the plurality of users; generating a second set of item types using a type selection model configured to identify item types semantically associated with the anchor item type, e.g., independently of the historic interaction data of the plurality of users; combining the first set of item types and the second set of item types to generate a list of target item types; generating a list of recommended information items based on the list of target item types; and in response to detection of a user interaction with the anchor item type by a first user, enabling display of at least a subset of information items in the list of recommended information items to the first user on an electronic device associated with the first user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of a process of recommending information items based on an anchor item type, in accordance with some embodiments;

FIG. 9 is a flow diagram of a process of determining a set of item types semantically associated with an anchor item type using machine learning, in accordance with some embodiments;

FIG. 10 is a flow diagram of a process of recommending information items based on two different lists of item types, in accordance with some embodiments;

FIG. 11 is a diagram of a process of selecting a subset of a list of recommended information items associated with a list of target item types for recommendation, in accordance with some embodiments; and

FIG. 12 is a flowchart illustrating a method for information item recommendation, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for recommending, ranking, and/or presenting information items (e.g., data items representative of information of product items) on a cloud-based service platform according to a list of item types that are associated with an anchor item type based on a persona (also called a user class). Examples of user classes include, but are not limited to, a “Cooking” user class, a “Pet Dog” user class, a “Beauty” user class, a “New Parents” user class, etc. In some embodiments, the service platform includes a user-persona centric recommendation module configured to determine a list of item types (e.g., general merchandise item types) associated with the anchor item type (e.g., a grocery item type) based on the user class of the user and provide information items indicating additional items corresponding to the list of item types on an interface page. Further, in some embodiments, an online application may be executed to provide one or more services to registered users and/or guest users. A user may select an information item corresponding to a first item type, e.g., a food or consumable product such as a bag of apples) to add the product into a virtual shopping cart. The application may identify a list of items of a second category, e.g., general merchandise items such as baby utensils or baby bibs, associated with the first information item based on a “New Parents” user class, and displays information items representing these general merchandise items in response to the user's selection of the food and consumable product. The recommendation module enhances an engagement level of the user of an item of the anchor item type with one or more different item types, as these different item types are accurately identified based on the user's associated user class.

In some embodiments, the list of target item types corresponding to the recommended information items combines a first list of item types that are involved in past interactions of a plurality of users jointly with an anchor item type and a second list of item types that are semantically associated with the anchor item type. The first list of item types may be determined based on co-bought behaviors demonstrated by the plurality of users belong to the same user class of the user. In some embodiments, a large language model (LLM) may be applied to determine the second list of item types that are semantically associated with the anchor item type for the user class. As such, the list of target item types may couple the LLM with the co-bought behavior in the context of user affinities, and may recommend more relevant information items for the user who has interacted with the information item associated with the anchor item type.

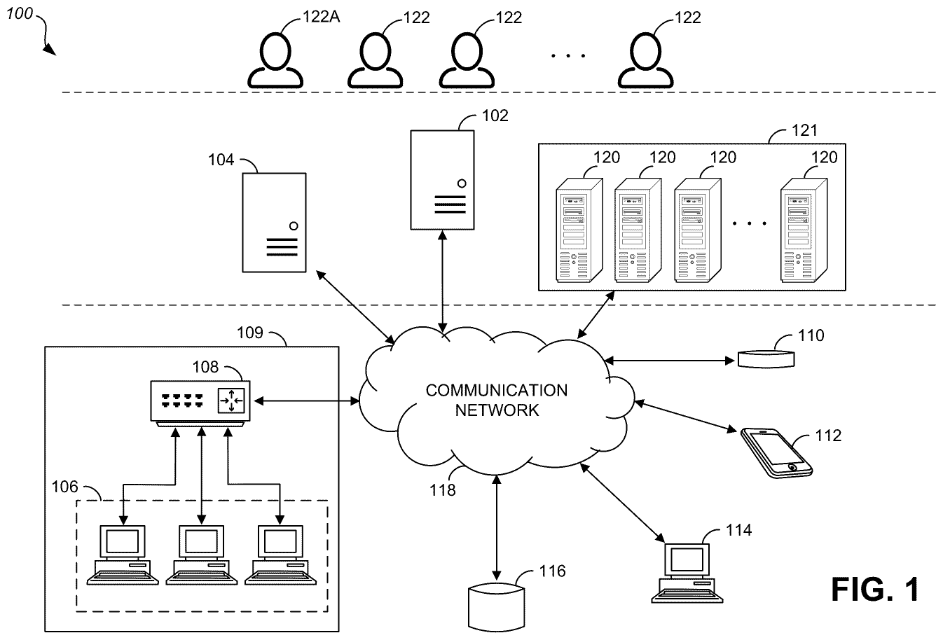

FIG. 1 is a network environment configured to provide a user application (e.g., a network interface application, an online shopping application, etc.) to a plurality of tenants, in accordance with some embodiments. The network environment 100 includes a plurality of devices or systems configured to communicate over one or more network channels, illustrated as a network cloud 118. For example, in various embodiments, the network environment 100 can include, but is not limited to, a recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the recommendation computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the recommendation computing device 102 over the communication network 118. The workstation(s) 106 may send data to, and receive data from, the recommendation computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the recommendation computing device 102 over the communication network 118.

In some examples, the recommendation computing device 102 may execute one or more models, such as a trained classifier, a type selection model, a feature extraction model, a large language model (LLM), etc., to identify one or more information items for a user of a first user class among a set of information items of a particular object class based on engagement of other users of the first user class with the set of information items. The recommendation computing device 102 may transmit the one or more identified information items to the web server 104 over the communication network 118, and the web server 104 may present the one or more identified information items on a screen of an electronic device associated with the user.

The recommendation computing device 102 is further operable to communicate with the database 116 over the communication network 118. For example, the recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation computing device 102, in some examples, the database 116 can be a local storage device, such as a hard drive, a non-volatile memory, or a USB stick. The recommendation computing device 102 may store purchase data received from the web server 104 in the database 116. The recommendation computing device 102 may also receive from the web server 104 user session data identifying events associated with browsing sessions, and may store the user session data in the database 116.

In some examples, the recommendation computing device 102 generates training data for a plurality of models (e.g., a type selection model, a user classifier, etc.) based on image data, historical user session data, etc. The recommendation computing device 102 may train the models based on their corresponding training data and may store the models in a database, such as in the database 116 (e.g., a cloud storage).

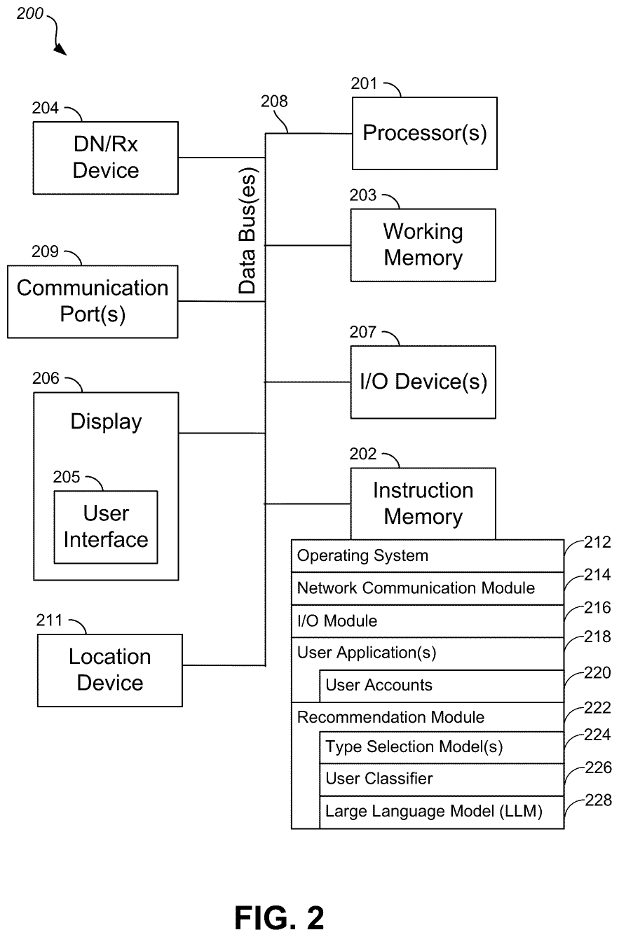

The models, when executed by the recommendation computing device 102, allow the recommendation computing device 102 to recommend and rank interface elements related to information items to be displayed to a user 122. For example, the recommendation computing device 102 may obtain the models from the database 116. The recommendation computing device 102 may further execute the models (e.g., a type selection model 224 in FIG. 2) to generate a set of item types semantically associated with an anchor item type for a user class independently of historic interaction data available to the computing device 102. The recommendation computing device 102 may then execute the models (e.g., a user classifier 226 in FIG. 2) to identify, among a plurality of users, a subset of users that are classified in a user class.

In some embodiments, the recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, recommendation computing device 102 may generate ranked item recommendations for items to be displayed on the website to a user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and customer computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the recommendation computing device 102 and/or the cloud-based engine 121. In some embodiments, the recommendation computing device 102 and/or the cloud-based engine 121 obtains (e.g., from the database 116) historic interaction data associated with past interactions of a plurality of users 122 with a plurality of information items. Each information item corresponds to a respective item type. The recommendation computing device 102 and/or the cloud-based engine 121 generates a first set of item types including item types involved in the past interactions jointly with an anchor item type based on the historic interaction data of the plurality of users 122. The recommendation computing device 102 and/or the cloud-based engine 121 generate a second set of item types semantically associated with the anchor item type (e.g., for a user class) using a type selection model. The type selection model (e.g., an LLM) is applied independently of the historic interaction data of the plurality of users 122. The recommendation computing device 102 and/or the cloud-based engine 121 combines the first set of item types and the second set of item types to generate a list of target item types, generates a list of recommended information items based on the list of target item types, and in response to detection of a user interaction with the anchor item type by a first user 122A, enables display of at least a subset of information items in the list of recommended information items to the first user 122A on an electronic device associated with the first user 122A.

FIG. 2 is a block diagram of a computing device 200, in accordance with some embodiments of the present teaching. In some embodiments, each of the recommendation computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the recommendation computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the recommendation computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the recommendation computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the recommendation computing device 102 may determine a local geographical area (e.g., town, city, state, etc.) of its position.

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online interface application that may provide online services to registered users and/or guest users; and
Recommendation module 222 that is executed to generate a list of target item types combining a first set of item types that were previously co-bought with an anchor item type and a second set of item types semantically associated with the anchor item type, prepare a list of recommended information items based on the list of target item types, and present a subset of the recommended information items in response to detection of a user interaction with the anchor item type. I in some embodiments, the second set of item types are semantically associated with the anchor item type for a user class, and in accordance with a determination that the first user belongs to the user class, the subset of the recommended information items is presented.

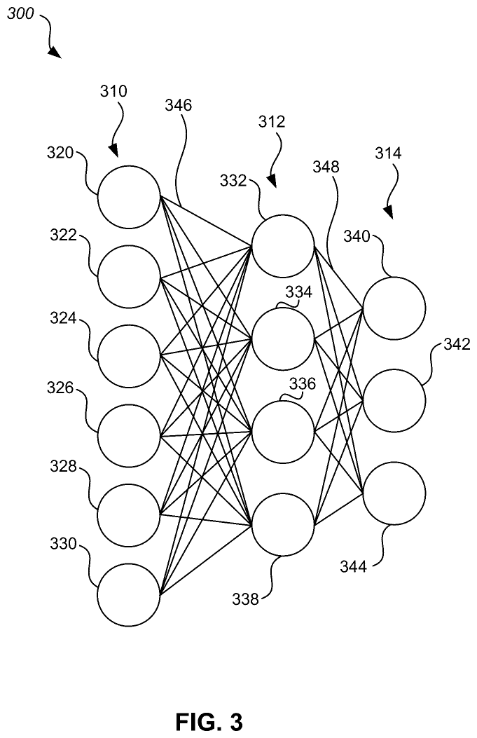

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by:

$${x}_{j}^{( n + 1 )} = f ( {\sum }_{i} {x}_{i}^{( n )} \cdot {w}_{i , j}^{( n )} ) \qquad ( 1 )$$

where the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} ) \qquad ( 3 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} ) \qquad ( 4 )$$

if the (n+1)-th layer is the output layer 34, wherein f′ is the first derivative of the activation function, and yⱼ⁽ⁿ⁺¹⁾ is the comparison training value for the j-th node of the output layer 314.

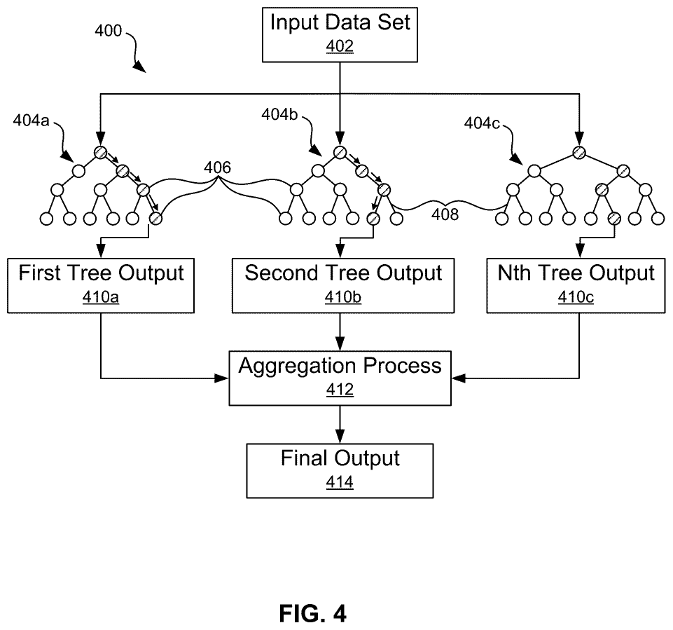

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

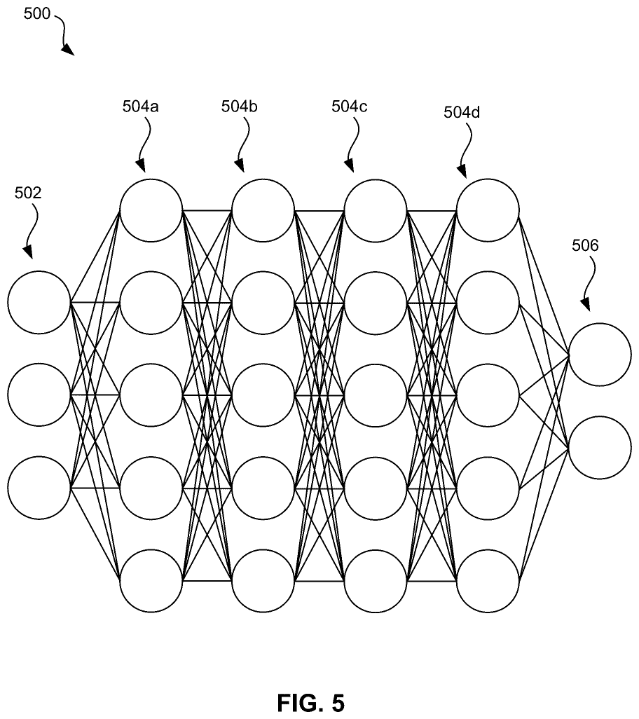

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )} \qquad ( 8 )$$

where d represents one or more features of the independent variable x.

It will be appreciated that automated item recommendation, as disclosed herein, particularly for large platforms such as e-commerce network platforms, is only possible with the aid of computer-assisted machine-learning algorithms and techniques, such as the disclosed type selection model 224 or user classifier 226. In some embodiments, item recommendation processes including the trained type selection model 224 or the trained user classifier 226 are used to perform operations that cannot practically be performed by a human, either mentally or with assistance. Such operations include, but not limited to, automated extraction of information of a plurality of items from a database (e.g., a database 116 in FIG. 1) and identification of associated item types based on the extracted information, e.g., for a particular user class and a particular anchor item type. In some situations, the database stores information of millions of items, which cannot practically be processed by a human. It will be appreciated that a variety of item recommendation techniques can be used alone or in combination to further determine a list of recommended items corresponding to relevant item types in the context of different user classes.

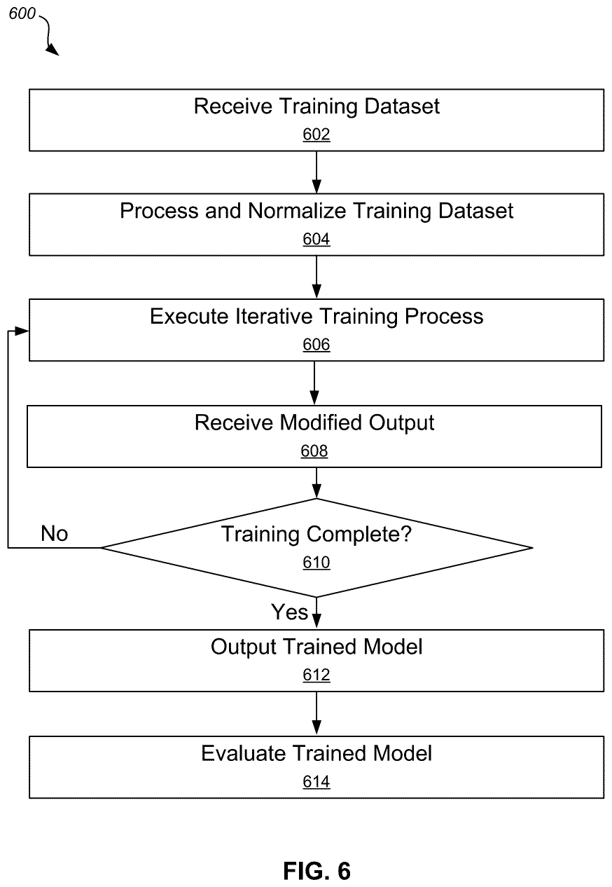

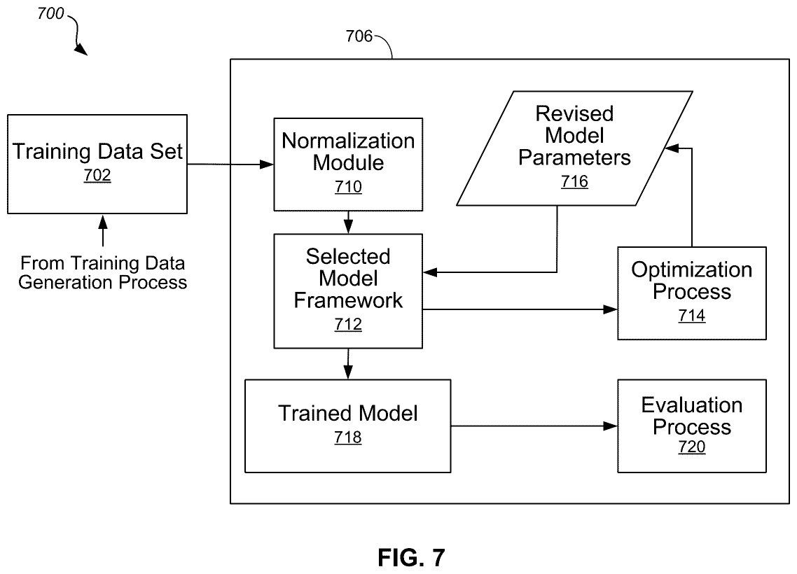

In some embodiments, an item recommendation method can include and/or implement one or more trained models, such as a trained type selection model 224 and a trained user classifier 226. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained type selection model 224 or a trained user classifier 226 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) type selection model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

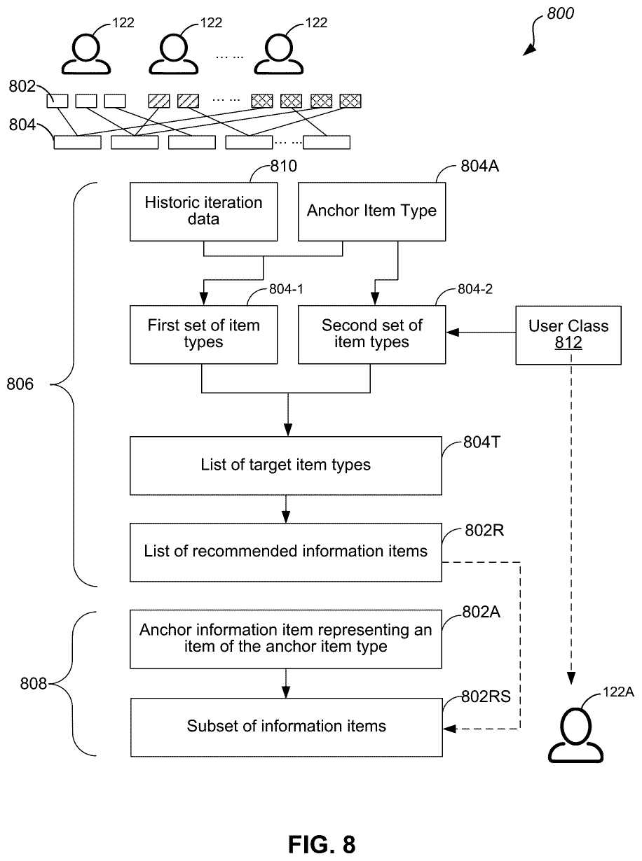

FIG. 8 is a flow diagram of a process 800 of recommending information items 802R based on an anchor item type 804A, in accordance with some embodiments. This process 800 is implemented by a system (e.g., including a recommendation computing device 102 and/or a cloud-based engine 121), and may include a first list preparation stage 806 and a second list application stage 808. During the first list preparation stage 806, a list of recommended information items 802R corresponding to a list of target item types 804T that are associated with the anchor item type 802A for a user class 812 is generated. The first preparation stage 806 may be implemented upon a request, according to a predefined schedule, and/or periodically (e.g., every day), such that the list of recommended information items 802R remains updated and ready to be used for users 122. During the second list application stage 808, an anchor information item 802A representing an item of the anchor item type 804A is displayed on an electronic device associated with a first user 122A. Upon detecting the first user's interaction with the displayed anchor information item 802A, at least a subset of information items 802RS in the list of recommended information items 802R is extracted for display on the electronic device associated with the first user 122A. The second list application stage 808 may be implemented in real time and ad hoc in response to a user 122 (e.g., of the user class 812) based on the list of recommended information items 802R that is updated and kept ready for use during the first list preparation stage 806.

In some embodiments, a cloud-based service platform executes a user application via an Internet browser or a dedicated application. The user application may have a plurality of user accounts 220 (e.g., registered user accounts or guest user accounts) associated with a plurality of users 122. The user application is configured to enable a user interface to present a plurality of information items 802 associated with different items to the plurality of users 122. Each user 122 may interact with an information item 802 on the user interface to search for, review, add-to-cart, place an order for, and/or return an item corresponding to the information item 802 on the cloud-based service platform. A user's interaction with the information items 802 is monitored and recorded. In some embodiments, historic interaction data 810 are generated based on past interactions of the plurality of users 122 with the plurality of information items 802. For example, the historic interaction data 810 includes one or both of a selection of a first information item (e.g., the anchor information item 802A) to add an item corresponding to the selected first information item into a shopping basket or a selection of a second information item to open a page of the selected second information item for further review. The historic interaction data 810 are applied to generate the list of recommended information items 802R during the first list preparation stage 806, while real-time interaction data are applied to detect a user interaction with the anchor information item 802A and enable selected presentation of the list of recommended information items 802R during the second list application stage 808.

In some embodiments, the historic interaction data 810 associated with past interactions of a plurality of users 122 with a plurality of information items 804 is obtained, e.g., from a database 116 (FIG. 1). Each information item 802 represents a respective item belonging to a respective item type 804. Based on the historic interaction data 810 of the plurality of users 122, the system generates a first set of item types 804-1 including item types that are involved in the past interactions jointly with the anchor item type 804A. Stated another way, items of the first set of item types 804-1 have high probabilities of being co-bought with an item of the anchor item type 804A in the past interactions. In some embodiments, the plurality of users 122 belong to the same user class 812. In some embodiments, the plurality of users 122 do not belong to the same user class 812. The system further generates a second set of item types 804-2 that are semantically associated with the anchor item type 804A based on a type selection model 224 (FIG. 2). The type selection model 224 is applied to identify the second set of item types 804-2 semantically associated with the anchor item type 804A. An example of the type selection model 224 is an LLM. The second set of item types 804-2 is generated independent of the historic interaction data of the plurality of users 122. In some embodiments, the second set of item types 804-2 are semantically associated with the anchor item type 804A for at least users 122 of the user class 812. A list of target item types 804T is generated to combine the first set of item types 804-1 and the second set of item types 804-2, and further applied to identify a list of recommended information items 802R. In some embodiments, the target items types 804T correspond to a collection of physical items that is represented by a collection of information items having a large number of information items, and the recommended information items 802R are selected from the collection of information items of the target items types 804T based on trending information and/or according to a round-robin scheme. In some embodiments, the system detects a user interaction with an information item 802A corresponding to the anchor item type 804A by a first user 122A, and enables display of at least the subset of information items 804RS in the list of recommended information items 804R to the first user 122A on an electronic device associated with the first user 122A. The system generates instructions configured to display an interface including the subset of information items 802RS on the electronic device associated with the first user 122A.

In some embodiments, information items 802R associated with the anchor item type 804A are recommended based on the user class 812. A list of target item types 804T associated with the anchor item type 804A for the user class 812 may be generated. In some embodiments, the list of target item types 804T includes at least a first set of item types 804-1 including item types that are involved in past interactions of a plurality of users 122 of the user class 812 jointly with the anchor item type 804A. Alternatively, in some embodiments, the list of target item types 804T includes at least a second set of item types 804-2 that are semantically associated with the anchor item type 804A for the user class 812, e.g., using a type selection model 224. Alternatively, in some embodiments, the list of target item types 804T includes both the first set of item types 804-1 and the second set of item types 804-2. The system identifies a list of recommended information items 802R corresponding to the list of target item types 804T for the user class 812. Upon detecting a user interaction with an anchor information item 802A corresponding to the anchor item type 804A by a first user 122A, the system enables display of at least a subset of information items 804RS in the list of recommended information items 804R to the first user 122A on an electronic device associated with the first user 122A.

Additionally, in some embodiments, the system determines whether the first user 122A belongs to the user class 812, and applies the list of recommended information items 804R associated with the user class 812 in accordance with a determination that the first user 122A belongs to the user class 812. Alternatively, the list of recommended information items 804R associated with the user class 812 may be applied independently of whether the first user 122A belongs to the user class 812. In some embodiments, the first user 122A belongs to a plurality of user classes 812, and a list of recommended information items 804R may be customized based on the anchor item type 804A and the user class 812. Stated another way, the same anchor item type 804A may be associated with different lists of recommended information items 802R for different user classes 812, and different anchor item types 804A may be associated with different lists of recommended information items 802R for the same user class 812.

In some embodiments, the first user 122A is classified to the user class 812 based on a subset of the historic interaction data 810 associated with the first user 122A. The anchor item type 804A is associated with the list of target item types 804T and the list of recommended information items 802R for the user class 812. The anchor item type 804A corresponds to one or more items associated with one or more anchor information items 802, so does each target item type 804T correspond to one or more target items associated with one or more target information items 802. In some embodiments, two different user classes 812 share the same list of target item types 804T and the list of recommended information items 802R. Conversely, in some embodiments, for two different user classes 812, the same anchor item type 804A is associated with two different lists of target item types 804T and two different lists of recommended information items 802R. T

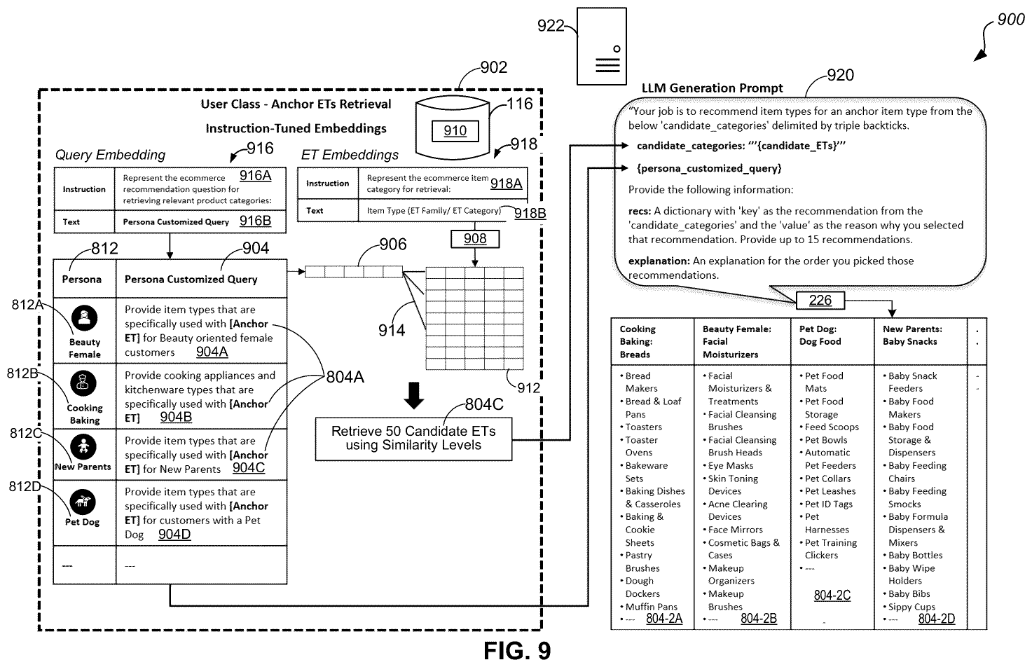

FIG. 9 is a flow diagram of a process 900 of determining a second set of item types 804-2 semantically associated with an anchor item type 804A using machine learning, in accordance with some embodiments. The process 900 is implemented by a system (e.g., including a recommendation computing device 102 and/or a cloud-based engine 121), independently of historic interaction data 810 (FIG. 8) associated with past interactions of a plurality of users 122 with a plurality of information items 802. In some embodiments, the type selection model 224 includes at least a feature extraction model 902. The system may apply the feature extraction model 902 to process a first query 904 for identifying item types associated with the anchor item type 804T to determine a query embedding 906. The system may apply the feature extraction model 902 to process a second query 908 for identifying a collection of item types 910 to determine a plurality of item type embeddings 912. In some embodiments, the collection of item types 910 correspond to a collection of items represented by, and may be stored in a database 116 (FIG. 1) jointly with, a collection of information items 802 (e.g., detailed description, brief description, names, materials, manufacturers, etc.). The collection of item types 910 is extracted from the database 116 and used to determine the plurality of item type embeddings 912. Alternatively, in some embodiments, the collection of item types 910 is not stored in the database 116, while the collection of information items 802 is stored in the database 116. The collection of information items 802 is extracted from the database 116 and used to determine the plurality of item type embeddings 912. The system determines a respective similarity level 914 between each of the plurality of item type embeddings 912 with the query embedding 906. Based on the respective similarity levels 914, the system selects a plurality of candidate item types 804C corresponding to the highest similarity levels among the collection of item types 910.

The first query 904 includes information identifying the anchor item type 804T. In some embodiments, the first query 904 is based on a user class 812 (FIG. 8) and further includes information identifying the user class 812. For example, a “Beauty Female” user class 812A is associated with users 122 who are interested in female beauty products, and a query 904A for the user class 812 is “Provide item types that are specifically used with a moisturizer for Beauty oriented female customers,” where the anchor item type 804A is “moisturizer.” A “Cooking Baking” user class 812B is associated with users 122 who are interested in cooking and baking products, and a query 904B for the user class 812B is “Provide cooking appliances and kitchenware types that are specifically used with breads,” where the anchor item type 804A is “breads.” A “New Parents” user class 812C is associated with users 122 who are new parents, and a query 904C for the user class 812C is “Provide item types that are specifically used with baby snacks for New Parents,” where the anchor item type 804A is “Baby Snacks.” A “Pet Dog” user class 812D is associated with users 122 who have dogs as pets, and a query 904D for the user class 812D is “Provide item types that are specifically used with dog food for a Pet Dog,” where the anchor item type 804A is “Dog Food.” In some embodiments, each of the user classes 812A-812D is selected from a plurality of predefined user classes 812. Further, in some embodiments, historic interaction data 810 are processed (e.g., by a classifier 226 in FIG. 2) to determine the predefined user classes 812.

In some embodiments, the feature extraction model 902 includes an instructor-based machine learning model (also called an instruction-finetuned text embedding model), which is configured to generate text embeddings tailored to a first task 916 of represent the query for candidate item types 804C associated with the anchor item type 804T and a second task 918 of represent the collection of information items 910 stored in the database 116. The tasks 916 and 918 are defined by task instructions 916A and 918A, and text input 916B or 918B are embedded together with instructions 916A or 918A explaining the use cases (e.g., task and domain descriptions), respectively. In some embodiments, the instruction-finetuned text embedding model is a single embedder configured to generate text embeddings tailored to different downstream tasks and domains, without any further training. In some embodiments, instructions are annotated for a plurality of tasks (e.g., >300 tasks) and train the instruction-finetuned text embedding model on a multitask mixture with a contrastive loss. For example, the instruction-finetuned text embedding model may be evaluated on 70 embedding evaluation tasks (64 of which are unseen during training), ranging from classification and information retrieval to semantic textual similarity and text generation evaluation. Although specific embodiments are discussed herein, it will be appreciated that any number of embedding evaluation tasks may be used to train or evaluate an instruction-finetuned text embedding model.

In some embodiments, the type selection model 224 includes a large language model (LLM) 228. In some embodiments, the LLM 228 is provided by a third-party server 922. The system generates a prompt 920 for identifying the second set of item types 804-2 associated with the anchor item type 804A, and sends the prompt 920 to the third-party server 922. The prompt 920 includes information of one or more of: the anchor item type 804A, a user class 812, and a plurality of candidate item types 804C. In some embodiments, the prompt 920 of the LLM 228 includes the first query 904 including the anchor item type 804A and the user class 812. The system receives, from the third-party server 922, a response including the second set of item types 804-2 selected from the candidate item types 804C. Conversely, in some embodiments, the LLM 228 is executed by the system. A prompt 920 for identifying the second set of item types 804-2 associated with the anchor item type 804A is generated, the prompt 920 may be processed using the LLM 228, and a response may be provided to the prompt 920.

In some embodiments, the second set of item types 804-2 includes a predefined number (e.g., 10) of item types. For example, each of the sets of item types 804-2A, 804-2B, 804-2C and 804-2D includes 10 item types identified for a respective one of the queries 904A, 904B, 904C, and 904D. In some embodiments, the LLM 228 is applied jointly with the feature extraction model 902. The feature extraction model 902 is used to narrow down the collection of item types 910 associated with the collection of information items in the database 116 to the plurality of candidate item types 804C (e.g., narrow down more than 1000 item types to 50 candidate item types). Given the smaller number of candidate item types 804C, the LLM 228 may be executed efficiently to identify the second set of item types 804-2 (e.g., 10 item types 804-2). Alternatively, in some embodiments, the feature extraction model 902 is not applied, and the collection of item types 910 associated with the collection of information items is used as candidate item types from which the LLM 228 is directly applied to identify the second set of item type 804-2. For example, the LLM 228 is applied to identify 10 item types of the second set of item types 804-2 from 1000 item types corresponding to the collection of information items.

In some embodiments, one or more filtering and/or review processes may be implemented at various stages to identify and/or prevent generation of undesirable content. For example, one or more filtering processes may be applied to identify, remove, and/or otherwise eliminate undesirable content such as inappropriate item types, offensive item types, restricted item types, etc. Filtering may occur at any suitable stage of an LLM-based generation process of the second set of item types 804-2. Although specific embodiments are discussed herein, it will be appreciated that any suitable filtering may applied at any suitable steps of the disclosed methods.

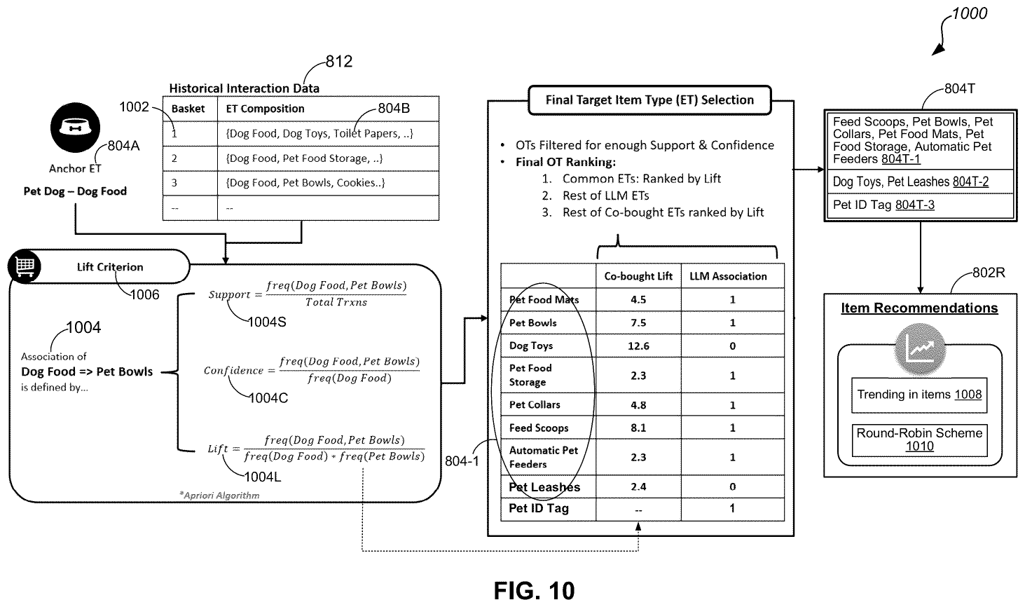

FIG. 10 is a flow diagram of a process 1000 of recommending information items 802R based on two different lists of item types 804-1 and 804-2, in accordance with some embodiments. The process 1000 is implemented by a system (e.g., including a recommendation computing device 102 and/or a cloud-based engine 121) based on historic interaction data 810 (FIG. 8) associated with past interactions of a plurality of users 122 with a plurality of information items 802. In some embodiments, the plurality of users 122 belong to a user class 812, and the historic interaction data 810 are associated with the user class 812. The process 1000 may be implemented upon a request, according to a predefined schedule, and/or periodically (e.g., every day), such that the list of recommended information items 802R remains updated and ready to be used for users 122 belonging to the user class 812. Alternatively, in some embodiments, the plurality of users 122 is not limited to the user class 812 and includes one or more other user classes distinct form the user class 812. The process 1000 may be implemented upon a request, according to a predefined schedule, or periodically (e.g., every day), such that the list of recommended information items 802R remains updated and ready to be used for the plurality of users 122. In some embodiments, the historic interaction data 810 includes information of a plurality of baskets 1002 of the plurality of users 122, and each basket 1002 includes one or more information items 802 corresponding to one or more items that attracted a respective user's interest or were ordered by the respective user 112 in the respective user's past transaction. Each information item of the plurality of baskets 1002 corresponds to a respective item type 804B, and each basket 1002 corresponds to one or more respective item types 804B. Different item types 804B may be co-bought in the same basket 1002. For example, “Dog Food” is co-bought with each of “Dog Toys,” “Toilet Papers,” “Pet Food Storage,” “Pet Bowls,” and “Cookies” in at least one of the baskets 1002.

In some embodiments, based on the historic interaction data 810, a first set of item types 804-1 associated with an anchor item type 804A (e.g., “Dog Food”) is generated. For example, the first set of item types 804-1 associated with “Dog Food” includes, but are not limited to, “Dog Toys,” “Toilet Papers,” “Pet Food Storage,” “Pet Bowls,” and “Cookies.” For each of the first set of item types 804-1, correlation information 1004 of the anchor item type 804A and a respective item type 804-1 is determined. The correlation information 1004 includes a support parameter 1004S, a confidence parameter 1004C, and a lift parameter 1004L. The first set of item types 804-1 satisfies a lift criterion 1006. In accordance with the lift criterion 1006, the system determines that the support parameter 1004S of each of the first set of item types 804-1 is greater than a first threshold and the confidence parameter 1004C of each of the first set of item types 804-1 is greater than a second threshold. In some embodiments not shown, the first set of item types 804-1 are organized based on the lift parameter 1004L of each item type 804-1. Further, in some embodiments, in accordance with the lift criterion 1006, a predefined number of item types 804-1 may be selected to form the first set of item types 804-1. The historical interaction data 810 may indicate that a plurality of item types 804 have been co-bought with the anchor item type 804A, and there may be only a subset (e.g., less than all) of the plurality of item types 804 satisfying the lift criterion 1006. Stated another way, in some embodiments, in accordance with the lift criterion 1006, the support parameter 1004S and the confidence parameters 1004C of the first subset of item types 804 are greater than their respective thresholds, the lift parameter 1004L of the first subset of item types 804 is greater than that of a remaining set of unselected item types 804, whose support parameter 1004S and confidence parameters 1004C are also greater than the first and second parameters, respectively.

In some embodiments, for each of the first set of item types 804-1, the support parameter 1004S (S), the confidence parameter 1004C (C), and the lift parameter 1004L (L) are represented as follows:

$$S = \frac{N ( AT , ET )}{{N}_{T X}} ; \qquad ( 8.1 )$$

$$C = \frac{N ( AT , ET )}{N ( A T )} ; and \qquad ( 8.2 )$$

$$L = \frac{N ( AT , ET )}{N ( AT ) \cdot N ( E T )} . \qquad ( 8.3 )$$

where N_{TX} is a total number of interactions in the historic interaction data 810, N(AT) is a number of interactions with the anchor item type 804A in the historic interaction data 810, N(ET) is a number of interactions including one or more items of the respective item type 804-1 in the historic interaction data 810, and N(AT,ET) is a number of interactions including both at least one item of the anchor item type 804A and at least one item of the respective item type 804-1 in the historic interaction data 810. In other words, the system determines the support parameter 1004S (S) based on a ratio of the number N(AT,ET) of interactions including both at least one item of the anchor item type 804A and at least one item of the respective item type 804-1 in the historic interaction data 810 and the total number N_{TX} of interactions in the historic interaction data 810. The system determines the confidence parameter 1004C (C) based on the ratio of the number N(AT,ET) and a number N(AT) of interactions with the anchor item type 804A in the historic interaction data 810. The system determines the lift parameter 1004L (L) based on the ratio of the number N(AT,ET) and a product of the number N(AT) and a number N(ET) of interactions including one or more items of the respective item type 804-1 in the historic interaction data 810.

Referring to FIG. 10, in some embodiments, the first set of item types 804-1 includes an item type of “Pet Bowls.” The support parameter 1004S, the confidence parameter 1004C, and the lift parameter 1004L are determined for the item type of “Pet Bowls” based on equations (8.1), (8.2), and (8.3). The support parameter 1004S and the confidence parameter 1004C of the item type of “Pet Bowls” satisfy the lift criterion 1006, and the lift parameter 1004L of the item type of “Pet Bowls” is equal to 7.5.

The system generates a list of target type types 804T based on the first set of item types 804-1 and the second set of item types 804-2. In some embodiments, the list of target item types 804T is ordered. A first portion of the list of target item types 804T-1 is included in both the first set of item types 804-1 and the second set of item types 804-2. A second portion of the list of target item types 804T-2 follows the first portion 804T-1, and is included only in the second set of item types 804-2 and not in the first set of item types 804-1. A third portion of the list of target item types 804T-3 follows the second portion 804T-2, and is included only in the first set of item types 804-1 and not in the second set of item types 804-2. In some embodiments, the system orders the first portion of the list of target item types 804T-1 based on a likelihood of each item type being engaged jointly with the anchor item type 804A, and the likelihood is determined based on the historic interaction data 810, e.g., represented by the lift parameter 1004L of the first set of item types 804T-1. In some embodiments, the system orders the second portion of the list of target item types 804T-2 based on a likelihood of each item type being engaged jointly with the anchor item type 804A, and the likelihood is determined based on the historic interaction data 810, e.g., represented by the lift parameter 1004L of the first set of item types 804T-1. For example, the first portion of the list of target item types 804T-1 includes an ordered list of target item types: feed scoops, pet bowls, pet collars, pet food mats, pet food storage, automatic pet feeders; the second portion of the list of target item types 804T-2 includes an ordered list of target item types: dog toys and pet leashes; and the third portion of the list of target item types 804T-1 includes a pet ID tag.

In some embodiments, the list of recommended information items 802R is generated based on the list of target item types 804T. In some embodiments, for each of the list of target item types 804T, a respective set of distinct items of the respective item type 804T is selected based on trending information 1008. The selected distinct items of the list of target item types 804T are further ranked based on the trending information 1008 to form an ordered list of recommended information items 802R. In some embodiments, each item type of the list of target item types 804T includes a respective number of selected items. A sum of respective numbers of selected items of the list of target item types 804T may be equal to a predefined number (e.g., 100). The trending information 1008 may include a number of items sold for a predefined length of sales history for each item of the respective set of distinct items corresponding to each target item type 804T. For example, the trending information 1008 may cover three months of sales history for each item in the respective set of distinct items selected for each target item type 804T.

In some embodiments, the selected distinct items corresponding to all of the list of target item types 804T are ranked based on a round-robin scheme 1010, thereby potentially allowing all of the list of target item types 804T to be included in the list of recommended information items 802R. For example, the list of target item types 804T may include N item types, and a most popular item in each target item type 810T may be identified and included as one of the first N items of the list of recommended information items 802R. The first N items may be ranked based on the trending information 1008. A second most popular item in each target item type 810T may be identified and included as one of the next N items of the list of recommended information items 802R. The next N items are further ranked based on the trending information 1008, and appended to the ranked set of the first N items in the list of recommended information items 802R. Items in each target item type 810T may be successively identified by descending popularity, ranked, and added to the list of recommended information items 802R until the list of recommended information items 802R is filled, e.g., until a number of items in the list of recommended information items 802R reaches a predefined number (e.g., 40).

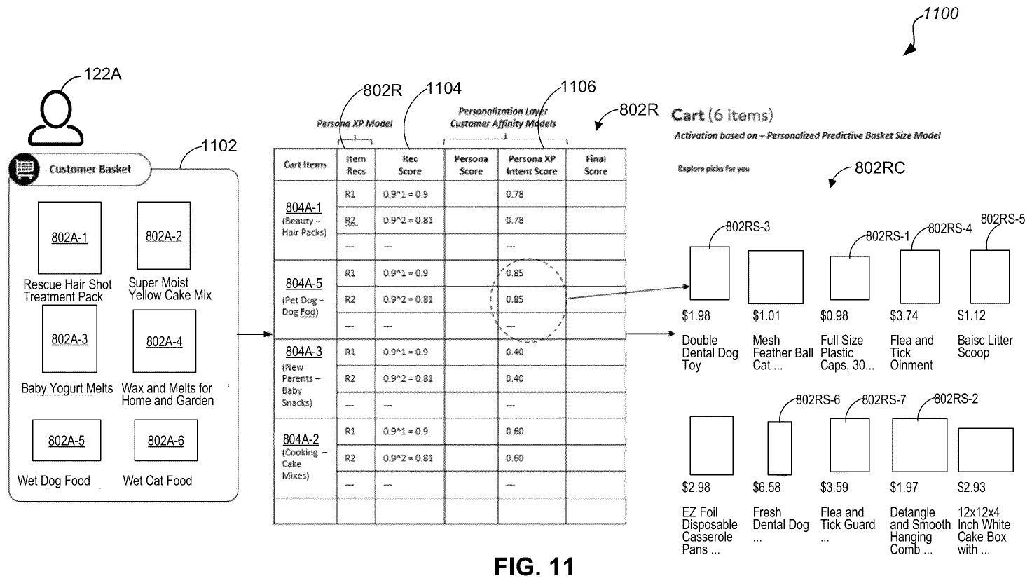

FIG. 11 is a diagram of a process 1100 of selecting a subset of a list of recommended information items 802RS associated with a list of target item types 802T for recommendation, in accordance with some embodiments. The process 1100 is implemented by a system (e.g., including a recommendation computing device 102 and/or a cloud-based engine 121) in real time in response to a user interaction with an anchor item type 804A by a first user 122A (e.g., of a user class 812). In some embodiments, the list of recommended information items 802R corresponding to the of list of target item types 802T have been created, stored in a database 116, and updated (e.g., periodically), independently of the user interaction with the anchor item type 804A by the first user 122A. In some embodiments, the first user 122A selects a plurality of anchor information items 802A (e.g., 802A-1, 802A-2, 802A-3, 802A-4, 802A-5, and 802A-6) to be added into a virtual shopping basket 1102 on a user application 218 (FIG. 2). A user interface associated with the virtual shopping basket 1102 is displayed on an electronic device associated with the first user 122A, and includes the plurality of anchor information items 802A. Each anchor information item 802A (e.g., 802A-1 to 802A-6) corresponds to a respective anchor item type 804A for which the system keeps a respective list of target item types 804T and a respective list of recommended information items 802R updated. In some embodiments, a comprehensive list of recommended information items 802RC is displayed and includes a respective subset of the list of recommended information items 802RS of each of the one or more recommended information item types 804A associated with the shopping basket 1102. The comprehensive list of recommended information items 802RC may include respective subsets of the recommended information items 802RS of all or less than all of the recommended information item types 804A in the shopping basket 1102.

In some embodiments, each anchor item 802A represents an item of an anchor item type 804A. For the anchor item type 804A, a list of recommended information items 802R is identified based on a user class 812 corresponding to the first user 122A. The first user 122A may belong to more than one user class 812. For example, the first user 122A belongs to a “Cooking” user class, a “New Parents” user class, a “Beauty” user class, and a “New Parents” user class. The system detects the first user 122A adding the anchor information item 802A-1 (e.g., Rescue Hair Shot Treatment Pack”) corresponding to the anchor item type 804A-1 into the virtual shopping basket 1102, and identifies the list of recommended information items 802R (e.g., including information items R1 and R2) associated with the anchor item type 804A-1 of a “Beauty” user class. Referring to FIG. 11, the system at least identifies the list of recommended information items 802R (e.g., including information items R1 and R2) associated with the anchor item types 804A-1, 804A-5, 804A-3, and 804A-2 of different user classes.

In some embodiments, for an anchor item type 804A-1, the list of recommended information items 802R (e.g., R1 and R2) is ordered according to a preference level 1104. The list of recommended information items 802R may have been ordered based on trending information 1008 and according to a round-robin scheme 1010. Each recommended information item 802R may be quantitatively assigned a respective preference level 1104 according to a respective position in the list of recommended information items 802R. For example, the preference level 1104 of a first recommended information item R1 corresponding to the anchor item type 804A-1 is 0.9, and the preference level 1104 of a second recommended information item R2 corresponding to the anchor item type 804A-1 is 0.81. The preference level 1104 of each recommended information item Rᵢ corresponding to the anchor item type 804A-1 is scaled by 0.9 from an immediately preceding recommended information item Rᵢ₋₁, where i is an integer equal to 2 or more.

In some embodiments, each anchor item type 804A is associated with a respective list of recommended information items 802R based on a respective user class 812. The respective list of recommended information items 802R corresponds an overall intent score 1106 of the anchor item type 804A indicating a frequency of users 122 of the respective user class 812 buy the anchor item type 804A and the respective list of recommended information items 802R jointly. For example, the overall intent scores 1106 for the anchor item types 804A-1, 804A-5, 804A-3, and 804A-2 are 0.78, 0.85, 0.4, and 0.6, respectively. Stated another way, the users 122 who buy the anchor item type 804A-5 have the strongest intent to buy recommended items 802R, compared with the users who buy the anchor item types 804A-1, 804A-3, and 804A-2. Additionally, in some embodiments, the system selects each of the subset of recommended information items 802RC from the list of recommended information items 802R associated with an anchor item types 802A based on a respective position of the respective information item 802RC in the list of recommended information items 802R or an overall intent score 1106 of the anchor item type 802A. In some embodiments, for an anchor item type 804A, the subset of information items 802RC includes a number of top-ranked information items in the list of information items, and the number may be determined based on the overall intent score 1106 of the anchor item type 804A. The higher the overall intent score of the anchor item type 804A, the greater the number of information items 802RC. For example, the overall intent score 1106 of the anchor item type 804A-5 is greater than that of the anchor item type 804A-3. The system selects two recommended information items (R1 and R2) that ranked the highest in the list of recommended information items 802R associated with the anchor item types 802A-5, while selecting only one recommended information item (R1) that ranked the highest in the list of recommended information items 802R associated with the anchor item types 802A-1.

In some embodiments, the system determines that the overall intent score 1106 of the anchor item type 804A is greater than a threshold intent score. The subset of information items 802RS is displayed in accordance with a determination that the overall intent score 1106 of the anchor item type 804A is greater than the threshold intent score. For example, referring to FIG. 11, in accordance with a determination that the overall intent scores 1106 of the anchor item types 804A-1, 804A-5, 804A-3, and 804A-2 are greater than the threshold intent score (e.g., 0.35), the system selects the subset of information items 802RS from the list of recommended information items 802R (e.g., including information items R1 and R2) associated with the anchor item types 804A-1, 804A-5, 804A-3, and 804A-2 of different user classes. In some embodiments, the system determines that an overall intent score 1106 of an anchor item type corresponding to an information item 802A-4 is not greater than a threshold intent score, and aborts enabling display of any information item in the list of recommended information items associated with the anchor item type corresponding to the information item 802A-4 (e.g., “Wax and Melts for Home and Garden).

Referring to FIG. 11, in some embodiments, the comprehensive list of recommended information items 802RC consolidates a respective subset of the list of recommended information items 802RS of each of one or more recommended information item types 804A (e.g., 804A-1, 804A-5, 804A-3, and 804A-2) associated with the shopping basket 1102. The comprehensive list of recommended information items 802RC is configured to be displayed in an ordered sequence, according to an interleaving scheme or successively according to an non-interleaving scheme. For example, information items R1 and R2 of each of the recommended information types 804A-1, 804A-5, 804A-3, and 804A-2 are selected for the first user 122A. In some embodiments, information items R1 and R2 of the recommended information type 804A-1 are followed by information items R1 and R2 of the recommended information type 804A-5, which are followed by information items R1 and R2 of the recommended information type 804A-3. The information items R1 and R2 of the recommended information type 804A-3 are followed by information items R1 and R2 of the recommended information type 804A-2. Alternatively, in some embodiments, information items R1 of the recommended information item types 804A-1, 804A-5, 804A-3, and 804A-2 are displayed successively, and followed by information items R2 of the recommended information item types 804A-1, 804A-5, 804A-3, and 804A-2, which are displayed successively as well. Additionally, in some embodiments, the recommended information item types 804A-1, 804A-5, 804A-3, and 804A-2 are ordered according to their respective overall intent scores 1106.

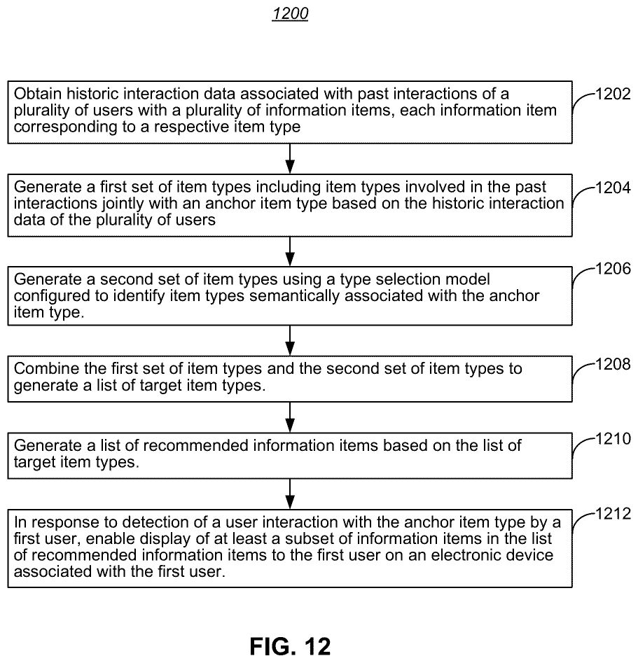

FIG. 12 is a flowchart illustrating a method 1200 for information item recommendation, in accordance with some embodiments. Method 1200 may be governed by instructions that are stored in a non-transitory computer readable storage medium and that are executed by one or more processors of a system (e.g., a recommendation computing device 102). Each of the operations shown in FIG. 12 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1200 may be combined and/or the order of some operations may be changed.

The system obtains (operation 1202) historic interaction data 810 (FIG. 8) associated with past interactions of a plurality of users 122 with a plurality of information items 802. Each information item 802 corresponds to a respective item type 804 (e.g., is associated with an item of the respective item type 804). The system generates (operation 1204) a first set of item types 804-1 including item types involved in the past interactions jointly with an anchor item type 804A based on the historic interaction data 810 of the plurality of users 122, generates (operation 1206) a second set of item types 804-2 using a type selection model 224 configured to identify item types semantically associated with the anchor item type 804A, and combines (operation 1208) the first set of item types 804-1 and the second set of item types 804-2 to generate a list of target item types 804T. The system generates (operation 1210) a list of recommended information items 802R based on the list of target item types 804T. In response to detection of a user interaction with the anchor item type 804A by a first user 122A, the system enables (operation 1212) display of at least a subset of information items 802RS in the list of recommended information items 802R to the first user 122A on an electronic device associated with the first user 122A.

In some embodiments, the type selection model 224 includes at least a feature extraction model 902 (FIG. 9). The system generates the second set of item types 804-2 by applying the feature extraction model to process a first query 904 for identifying item types associated with the anchor item type 804A to determine a query embedding 906; and process a second query for identifying a collection of item types 910 to determine a plurality of item type embeddings 912; determine a respective similarity level 914 between each of the plurality of item type embeddings 912 with the query embedding 906; and based on the respective similarity levels 914, select a plurality of candidate item types 804C corresponding to the highest similarity levels among the collection of item types 910.

In some embodiments, the second set of item types 804-2 is semantically associated with the anchor item type 804A for a user class 812 (FIG. 8). The system determines that the first user 122A is included in the user class 812 in response to detection of the user interaction with the anchor item type 804A by the first user 122A.

In some embodiments, the type selection model 224 includes a large language model (LLM) 228 provided by a third-party server 922 (FIG. 9). The system generates the second set of item types 804-2 by sending a prompt 920 for identifying the second set of item types 804-2 associated with the anchor item type 804A to the third-party server 922. The prompt 920 includes information of one or more of: the anchor item type 804A, a user class 812, and a plurality of candidate item types 804C. The system receives, from the third-party server, a response including the second set of item types 804-2 selected from the candidate item types 804C.

In some embodiments, the system classifies the first user 122A to a user class 812 based on a subset of the historic interaction data 810 associated with the first user 122A and identifies the anchor item type 804A based on the user class 812. The anchor item type 804A corresponds to one or more items associated with one or more information items 802.

In some embodiments, the system generates the first set of item types 804-1 by determining correlation information 1004 (FIG. 10) of the anchor item type 804A and a respective item type for each of the first set of item types 804-1. The correlation information 1004 includes a support parameter 1004S, a confidence parameter 1004C, and a lift parameter 1004L. The system determines that the support parameter 1004S of each of the first set of item types 804-1 is greater than a first threshold and that the confidence parameter 1004C of each of the first set of item types 804-1 is greater than a second threshold, and organizes the first set of item types 804-1 based on the lift parameter 1004L of each item type 804-1.

In some embodiments, the system determines the correlation information 1004 of the anchor item type 804A and the respective item type by: determining the support parameter 1004S based on a ratio of a number N(AT,ET) of interactions including both at least one item of the anchor item type 804A and at least one item of the respective item type in the historic interaction data 810 and a total number N_{TX} of interactions in the historic interaction data 810; determining the confidence parameter 1004C based on a ratio of the number N(AT,ET) and a number N(AT) of interactions with the anchor item type 804A in the historic interaction data 810; or determining the lift parameter 1004L based on a ratio of the number N(AT. ET) and a product of the number N(AT) and a number N(ET) of interactions including one or more items of the respective item type in the historic interaction data 810.

In some embodiments, the list of target item types 804T is ordered. The system identifies a first portion of the list of target item types 804T included in both the first set of item types 804-1 and the second set of item types 804-2, a second portion of the list of target item types 804T included only in the second set of item types 804-2 and not in the first set of item types 804-1; and a third portion of the list of target item types 804T that are included only in the first set of item types 804-1 and not in the second set of item types 804-2. The second portion follows the first portion, and the third portion follows the second portion.

In some embodiments, the system generates the list of target item types 804T by ordering the first portion of the list of target item types 804T based on a likelihood of each item type being engaged jointly with the anchor item type 804A. The likelihood is determined based on the historic interaction data 810.

In some embodiments, the system generates the list of recommended information items 802R. For each of the list of target item types 804T, the system identifies a set of respective information items 802 associated with a set of items based on trending information and orders respective information items 802 of the list of target item types 804T based on the trending information and according to a round-robin scheme.

In some embodiments, the system receives a request associated with the first user 122A to interact with an anchor information item 802A (e.g., 802A-1 to 802A-6 in FIG. 11). In accordance with a determination that the anchor information item 802A corresponds to an item of the anchor item type 804A, the system detects the user interaction with the anchor item type 804A by the first user 122A.

In some embodiments, the list of recommended information items 802R is ordered according to a preference level 1104. In response to detection of a user interaction with the anchor item type 804A by the first user 122A, the system selects each of the subset of information items 802RS based on a respective position of the respective information item in the list of recommended information items 802R or an overall intent score 1106 (FIG. 11) of the anchor item type 804A. Further, in some embodiments, the subset of information items 802RS has a number of top-ranked information items 802 in the list of recommended information items 802R, and the number is determined by the overall intent score 1106 of the anchor item type 804A. In some embodiments, the system determines that the overall intent score 1106 of the anchor item type 804A is greater than a threshold intent score. The subset of information items 802RS are displayed in accordance with a determination that the overall intent score 1106 of the anchor item type 804A is greater than the threshold intent score.

In some embodiments, the anchor item type 804A includes a first anchor item type 804A (e.g., “Hair Packs” 804A-1 in FIG. 11), and the subset of information items 802RS includes a subset of first information items 802 (e.g., 802RS-1 and 802RS-2 in FIG. 11). In response to detection of a user interaction with a second anchor item type 804A (e.g., “Dog Food” 804A-5 in FIG. 11) by the first user 122A, the system enables display of at least a subset of second information items 802 (e.g., 802RS-3 to 802RS-7 in FIG. 11) in a list of second information items 802 associated with the second anchor item type 804A to the first user 122A jointly with the subset of first information items 802. Further, in some embodiments, the subset of first information items 802 and the subset of second information items 802 are configured to be displayed in an ordered sequence of information items 802RC, according to an interleaving scheme or successively according to a non-interleaving scheme.

In some embodiments, the anchor item type 804A includes a first anchor item type 804A (e.g., “Hair Packs” 804A-1 in FIG. 11). In response to detection of a user interaction with a second anchor item type 804A (e.g., “Wax and Melts for Home and Garden” 804A-4 in FIG. 11) by the first user 122A, the system determines that an overall intent score 1106 of the second anchor item type 804A is not greater than a threshold intent score and aborts enabling display of any information item in a list of recommended information items 802R associated with the second anchor item type 804A to the first user 122A.

In some embodiments, the historic interaction data 810 includes one or both of: a selection of a first information item to add an item corresponding to the selected first information item into a shopping basket and a selection of a second information item to open a page of the selected second information item for further review.

In some embodiments, the system executes a user application 218 (FIG. 2) via an Internet browser or a dedicated application. The user application has a plurality of user accounts 220 (FIG. 2) associated with the plurality of users 122. The past interactions of the plurality of users 122 are associated with the plurality of information items 802 displayed on respective user interfaces of the user application. The subset of information items 802RS are displayed on the user interface of the user application.

Turning now to example embodiments in the following clauses:

Clause 1. A system, comprising: a non-transitory memory having instructions stored thereon; and at least one processor operatively coupled to the non-transitory memory, and configured to read the instructions to: obtain (operation 1202) historic interaction data associated with past interactions of a plurality of users with a plurality of information items, each information item corresponding to a respective item type; generate (operation 1204) a first set of item types including item types involved in the past interactions jointly with an anchor item type based on the historic interaction data of the plurality of users; generate (operation 1206) a second set of item types using a type selection model configured to identify item types semantically associated with the anchor item type; combine (operation 1208) the first set of item types and the second set of item types to generate a list of target item types; generate (operation 1210) a list of recommended information items based on the list of target item types; and in response to detection of a user interaction with the anchor item type by a first user, enable (operation 1212) display of at least a subset of information items in the list of recommended information items to the first user on an electronic device associated with the first user.

Clause 2. The system of clause 1, wherein the type selection model includes at least a feature extraction model, and the instructions to generate the second set of item types further comprises instructions to: apply the feature extraction model to: process a first query for identifying item types associated with the anchor item type to determine a query embedding; and process a second query for identifying a collection of item types to determine a plurality of item type embeddings; determine a respective similarity level between each of the plurality of item type embeddings with the query embedding; and based on the respective similarity levels, select a plurality of candidate item types corresponding to the highest similarity levels among the collection of item types.

Clause 3. The system of clause 1 or 2, wherein the second set of item types is semantically associated with the anchor item type for a user class, the system further comprising instructions to determine that the first user is included in the user class in response to detection of the user interaction with the anchor item type by the first user.

Clause 4. The system of any of clauses 1-3, wherein the type selection model includes a large language model (LLM) provided by a third-party server, and the instructions to generate the second set of item types further comprises instructions to: send a prompt for identifying the second set of item types associated with the anchor item type to the third-party server, the prompt including information of one or more of: the anchor item type, a user class, and a plurality of candidate item types; and receive, from the third-party server, a response including the second set of item types selected from the candidate item types.

Clause 5. The system any of clauses 1-4, further comprising instructions to: classify the first user to a user class based on a subset of the historic interaction data associated with the first user; and identify the anchor item type based on the user class, the anchor item type corresponding to one or more items associated with one or more information items.

Clause 6. The system of any of clauses 1-5, the instructions to generate the first set of item types further comprising instructions to: for each of the first set of item types, determine correlation information of the anchor item type and a respective item type, wherein the correlation information includes a support parameter, a confidence parameter, and a lift parameter; determine that the support parameter of each of the first set of item types is greater than a first threshold and the confidence parameter of each of the first set of item types is greater than a second threshold; and organize the first set of item types based on the lift parameter of each item type.

Clause 7. The system of clause 6, the instructions to determine the correlation information of the anchor item type and the respective item type further comprising instructions to: determine the support parameter based on a ratio of a number N(AT,ET) of interactions including both at least one item of the anchor item type and at least one item of the respective item type in the historic interaction data and a total number N_{TX} of interactions in the historic interaction data; determine the confidence parameter based on a ratio of the number N(AT,ET) and a number N(AT) of interactions with the anchor item type in the historic interaction data; or determine the lift parameter based on a ratio of the number N(AT,ET) and a product of the number N(AT) and a number N(ET) of interactions including one or more items of the respective item type in the historic interaction data.

Clause 8. The system of any of clauses 1-7, wherein the list of target item types is ordered, and the instructions to generate the list of target item types further comprise instructions to: identify a first portion of the list of target item types included in both the first set of item types and the second set of item types; identify a second portion of the list of target item types included only in the second set of item types and not in the first set of item types, the second portion following the first portion; and identify a third portion of the list of target item types that are included only in the first set of item types and not in the second set of item types, the third portion following the second portion.

Clause 9. The system of clause 8, wherein the instructions to generate the list of target item types further comprise instructions to order the first portion of the list of target item types based on a likelihood of each item type being engaged jointly with the anchor item type, the likelihood being determined based on the historic interaction data.

Clause 10. The system of any of clauses 1-9, wherein the instructions to generate the list of recommended information items further comprise instructions to: for each of the list of target item types, identify a set of respective information items associated with a set of items based on trending information; and order respective information items of the list of target item types based on the trending information and according to a round-robin scheme.

Clause 11. The system of any of clauses 1-10, further comprising instructions to: receive a request associated with the first user to interact with an anchor information item; and in accordance with a determination that the anchor information item corresponds to an item of the anchor item type, detect the user interaction with the anchor item type by the first user.

Clause 12. The system of any of clauses 1-11, wherein the list of recommended information items is ordered according to a preference level, the system further comprising instructions to, in response to detection of a user interaction with the anchor item type by the first user, select each of the subset of information items based on a respective position of the respective information item in the list of recommended information items or an overall intent score of the anchor item type.

Clause 13. The system of clause 12, wherein the subset of information items has a number of top-ranked information items in the list of recommended information items, and the number is determined by the overall intent score of the anchor item type.

Clause 14. The system of clause 12 or 13, further comprising instructions to determine that the overall intent score of the anchor item type is greater than a threshold intent score, wherein the subset of information items are displayed in accordance with a determination that the overall intent score of the anchor item type is greater than the threshold intent score.

Clause 15. The system of any of clauses 1-14, wherein the anchor item type includes a first anchor item type, and the subset of information items includes a subset of first information items, the system further comprising instructions to, in response to detection of a user interaction with a second anchor item type by the first user, enable display of at least a subset of second information items in a list of second information items associated with the second anchor item type to the first user jointly with the subset of first information items.

Clause 16. The system of clause 15, wherein the subset of first information items and the subset of second information items are configured to be displayed in an ordered sequence, according to an interleaving scheme or successively according to an non-interleaving scheme.

Clause 17. The system of any of clauses 1-16, wherein the anchor item type includes a first anchor item type, the system further comprising instructions to, in response to detection of a user interaction with a second anchor item type by the first user: determine that an overall intent score of the second anchor item type is not greater than a threshold intent score; and abort enabling display of any information item in a list of recommended information items associated with the second anchor item type to the first user.

Clause 18. The system of any of clauses 1-17, wherein the historic interaction data includes one or both of: a selection of a first information item to add an item corresponding to the selected first information item into a shopping basket; and a selection of a second information item to open a page of the selected second information item for further review.

Clause 19. The system of any of clauses 1-18, further comprising instructions to: execute a user application via an Internet browser or a dedicated application; wherein the user application has a plurality of user accounts associated with the plurality of users; wherein the past interactions of the plurality of users are associated with the plurality of information items displayed on respective user interfaces of the user application; and wherein the subset of information items are displayed on the user interface of the user application.

Clause 20. A non-transitory computer-readable storage medium, having instructions stored thereon, which when executed by one or more processors cause the processors to implement operations based on the instructions of the system of any of claims 1-19.

Clause 21. A method, comprising: at a system including a non-transitory memory having instructions stored thereon and at least one processor operatively coupled to the non-transitory memory and configured to read the instructions, implementing operations based on the instructions of the system of any of claims 1-19.

It should be understood that the particular order in which the operations in FIG. 12 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-13 are also applicable in an analogous manner to method 1200 described above with respect to FIG. 12. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain historic interaction data associated with past interactions of a plurality of users with a plurality of information items, each information item corresponding to a respective item type;
generate a first set of item types including item types involved in the past interactions jointly with an anchor item type based on the historic interaction data of the plurality of users;
generate a second set of item types using a type selection model configured to identify item types semantically associated with the anchor item type;
combine the first set of item types and the second set of item types to generate a list of target item types;
generate a list of recommended information items based on the list of target item types; and
in response to detection of a user interaction with the anchor item type by a first user, enable display of at least a subset of information items in the list of recommended information items to the first user on an electronic device associated with the first user.

2. The system of claim 1, wherein the type selection model includes at least a feature extraction model, and the instructions to generate the second set of item types further comprises instructions to apply the feature extraction model to:
process a first query for identifying item types associated with the anchor item type to determine a query embedding; and
process a second query for identifying a collection of item types to determine a plurality of item type embeddings;
determine a respective similarity level between each of the plurality of item type embeddings with the query embedding; and
based on the respective similarity levels, select a plurality of candidate item types corresponding to the highest similarity levels among the collection of item types.

3. The system of claim 1, wherein the second set of item types is semantically associated with the anchor item type for a user class, the system further comprising instructions to determine that the first user is included in the user class in response to detection of the user interaction with the anchor item type by the first user.

4. The system of claim 1, wherein the type selection model includes a large language model (LLM) provided by a third-party server, and the instructions to generate the second set of item types further comprises instructions to:
send a prompt for identifying the second set of item types associated with the anchor item type to the third-party server, the prompt including information of one or more of: the anchor item type, a user class, and a plurality of candidate item types; and
receive, from the third-party server, a response including the second set of item types selected from the candidate item types.

5. The system claim 1, further comprising instructions to:
classify the first user to a user class based on a subset of the historic interaction data associated with the first user; and
identify the anchor item type based on the user class, the anchor item type corresponding to one or more items associated with one or more information items.

6. The system of claim 1, the instructions to generate the first set of item types further comprising instructions to:
for each of the first set of item types, determine correlation information of the anchor item type and a respective item type, wherein the correlation information includes a support parameter, a confidence parameter, and a lift parameter;
determine that the support parameter of each of the first set of item types is greater than a first threshold and the confidence parameter of each of the first set of item types is greater than a second threshold; and
organize the first set of item types based on the lift parameter of each item type.

7. A non-transitory computer-readable storage medium, having instructions stored thereon, which when executed by one or more processors cause the processors to:
obtain historic interaction data associated with past interactions of a plurality of users with a plurality of information items, each information item corresponding to a respective item type;
generate a first set of item types including item types involved in the past interactions jointly with an anchor item type based on the historic interaction data of the plurality of users;
generate a second set of item types using a type selection model configured to identify item types semantically associated with the anchor item type;
combine the first set of item types and the second set of item types to generate a list of target item types;
generate a list of recommended information items based on the list of target item types; and
in response to detection of a user interaction with the anchor item type by a first user, enable display of at least a subset of information items in the list of recommended information items to the first user on an electronic device associated with the first user.

8. The non-transitory computer-readable storage medium of claim 7, wherein the list of target item types is ordered, and the instructions to generate the list of target item types further comprise instructions to:
identify a first portion of the list of target item types included in both the first set of item types and the second set of item types;
identify a second portion of the list of target item types included only in the second set of item types and not in the first set of item types, the second portion following the first portion; and
identify a third portion of the list of target item types that are included only in the first set of item types and not in the second set of item types, the third portion following the second portion.

9. The non-transitory computer-readable storage medium of claim 8, wherein the instructions to generate the list of target item types further comprise instructions to order the first portion of the list of target item types based on a likelihood of each item type being engaged jointly with the anchor item type, the likelihood being determined based on the historic interaction data.

10. The non-transitory computer-readable storage medium of claim 7, wherein the instructions to generate the list of recommended information items further comprise instructions to:
for each of the list of target item types, identify a set of respective information items associated with a set of items based on trending information; and
order respective information items of the list of target item types based on the trending information and according to a round-robin scheme.

11. The non-transitory computer-readable storage medium of claim 7, further comprising instructions to:
receive a request associated with the first user to interact with an anchor information item; and
in accordance with a determination that the anchor information item corresponds to an item of the anchor item type, detect the user interaction with the anchor item type by the first user.

12. A method, comprising:
at a system including a non-transitory memory having instructions stored thereon and at least one processor operatively coupled to the non-transitory memory and configured to read the instructions:
obtaining historic interaction data associated with past interactions of a plurality of users with a plurality of information items, each information item corresponding to a respective item type;
generating a first set of item types including item types involved in the past interactions jointly with an anchor item type based on the historic interaction data of the plurality of users;
generating a second set of item types using a type selection model configured to identify item types semantically associated with the anchor item type;
combining the first set of item types and the second set of item types to generate a list of target item types;
generating a list of recommended information items based on the list of target item types; and
in response to detection of a user interaction with the anchor item type by a first user, enabling display of at least a subset of information items in the list of recommended information items to the first user on an electronic device associated with the first user.

13. The method of claim 12, wherein the list of recommended information items is ordered according to a preference level, the method further comprising:
in response to detection of a user interaction with the anchor item type by the first user, selecting each of the subset of information items based on a respective position of the respective information item in the list of recommended information items or an overall intent score of the anchor item type.

14. The method of claim 13, wherein the subset of information items has a number of top-ranked information items in the list of recommended information items, and the number is determined by the overall intent score of the anchor item type.

15. The method of claim 13, further comprising:
determining that the overall intent score of the anchor item type is greater than a threshold intent score, wherein the subset of information items are displayed in accordance with a determination that the overall intent score of the anchor item type is greater than the threshold intent score.

16. The method of claim 12, wherein the anchor item type includes a first anchor item type, and the subset of information items includes a subset of first information items, the method further comprising:
in response to detection of a user interaction with a second anchor item type by the first user, enabling display of at least a subset of second information items in a list of second information items associated with the second anchor item type to the first user jointly with the subset of first information items.

17. The method of claim 16, wherein the subset of first information items and the subset of second information items are configured to be displayed in an ordered sequence, according to an interleaving scheme or successively according to an non-interleaving scheme.

18. The method of claim 12, wherein the anchor item type includes a first anchor item type, the method further comprising, in response to detection of a user interaction with a second anchor item type by the first user:
determining that an overall intent score of the second anchor item type is not greater than a threshold intent score; and
aborting enabling display of any information item in a list of recommended information items associated with the second anchor item type to the first user.

19. The method of claim 12, wherein the historic interaction data includes one or both of:
a selection of a first information item to add an item corresponding to the selected first information item into a shopping basket; and
a selection of a second information item to open a page of the selected second information item for further review.

20. The method of claim 12, further comprising:
executing a user application via an Internet browser or a dedicated application;
wherein the user application has a plurality of user accounts associated with the plurality of users;
wherein the past interactions of the plurality of users are associated with the plurality of information items displayed on respective user interfaces of the user application; and
wherein the subset of information items are displayed on the user interface of the user application.
